(19) United States
(12) Patent Application Publication
(10) Pub. No.: US 2003/0092954 A1
(43) Pub. Date: May 15, 2003

(54) Nuclear fuel dissolution

(76) Inventor: Peter Jonathan Watson Rance, Seascale (GB)

Correspondence Address: MYERS BIGEL SIBLEY & SAJOVEC, PO BOX 37428, RALEIGH, NC, 27627, US

(21) Appl. No.: 10/148,558

(22) PCT Filed: Dec. 4, 2000
(86) PCT No.: PCT/GB00/04592

(51) Int. Cl. G21F 9/00

(52) U.S. Cl. 588/1

(57) ABSTRACT

The invention comprises a method for the dissolution of spent nuclear fuel pins or contaminated cladding, the method comprising contacting together the pins and both nitric and fluoroboric acids which, preferably, are present in admixture. The combination of acids dissolves both cladding and fuel at an acceptable rate and provides a solution suitable for use in subsequent purification processes such as the Purex process.

### FIELD OF THE INVENTION

This invention relates to methods for dissolving spent nuclear fuel.

### BACKGROUND TO THE INVENTION

Nuclear fuel is typically manufactured and used in the form of a fuel rod or pin. A fuel pin comprises a long tube in which radioactive pellets of uranium oxide are encased. The tube is known as cladding and typically is made from an alloy of zirconium called zircaloy.

In order to dissolve spent fuel the fuel pins are first cut into small pieces and then fed into a digester where nitric acid dissolves the uranium and its fission products but not the cladding. After this leaching stage, the hulls (chopped cladding) and other solid debris are rinsed and monitored for undissolved fuel content. The hulls are then packed into drums and encapsulated in cement for disposal.

The procedure is complicated by the need to provide for removing the empty cladding hulls. Much remote mechanical handling is involved and it has been appreciated that a continuous dissolution process would offer considerable advantages. One such process makes use of a continuous dissolver in the form of a wheel with the rim divided by radial partitions into twelve sectors closed at the periphery but open inwards. The wheel rotates in a vertical plain with the lower part immersed in hot nitric acid in a tank. Chopped fuel is loaded by a chute into a compartment entering the acid. The rate of revolution allows essentially complete dissolution before completion of the cycle. As the compartment rises to the top of the wheel, the hulls fall into a discharge chute for rinsing and disposal.

The above described known processes accordingly involve a considerable complexity of handling or of the equipment itself in order to cope with the cladding hulls. It would be advantageous if the dissolution stage could involve less mechanical handling and/or the need for such complex equipment.

### STATEMENTS OF THE INVENTION

According to the present invention there is provided a method for the dissolution of spent nuclear fuel pins, the method comprising contacting together the pins and both nitric and fluoroboric acids. Preferably the nitric and fluoroboric acids are present in admixture.

The ability to dissolve both the cladding and the fuel pellets using a combination of nitric and fluoroboric acids is surprising having regard to the properties of the individual acids and their expected effect of one acid upon the other on the dissolution processes which are involved. Nitric acid reduces the rate of cladding dissolution and relatively high concentrations of nitric acid have been required to dissolve the uranium dioxide fuel and give a feed suitable for use in a subsequent purification process such as the Purex process. Furthermore the treatment of waste solutions containing a high fluoride ion concentration is difficult.

In spite of the adverse expectations of one skilled in the art, it has surprisingly been found that the combination of nitric acid and fluoroboric acid will dissolve both the cladding and the fuel at an acceptable rate and will result in a solution in which the level of fluoride ion concentration is such that processes such as the Purex process can be operated successfully.

Preferably the concentration of nitric acid is higher than that of fluoroboric acid.

Preferably the concentration of nitric acid is within the range of from 4 to 8 mol/l. More preferably the concentration of nitric acid is about 6 mol/l.

Preferably the concentration of fluoroboric acid is within the range of from 0.1 to 2 mol/l. More preferably the concentration of fluoroboric acid is about 0.5 mol/l.

A process in accordance with the present invention may form part of a nuclear fuel reprocessing procedure. Alternatively, it may be employed for the treatment of hulls prior to disposal. As the major activity associated with hulls is due to undissolved fuel trapped within crimped hulls, the present process is particularly advantageous since it results in the dissolution of both cladding and fuel.

### DETAILED DESCRIPTION OF THE INVENTION

The fastest cladding dissolution rates occur at relatively high fluoroboric acid concentration (approximately 4 mol/l) and a low nitric acid concentration (less than 1 mol/l). The dissolution of both oxidised and unoxidised zircaloy cladding takes place in HBF₄/HNO₃. Such a mixture will also dissolve the UO₂ fuel pellets. Although the fastest cladding dissolution rates are achieved at relatively high fluoroboric acid concentration and low nitric acid concentration, a higher nitric acid level is preferred to dissolve the UO₂ fuel and give a feed suitable for processing in the Purex process. It is advantageous to keep the HBF₄ concentration as low as possible since precipitation of zirconium fluorides means that the treatment of waste solutions containing high fluoride ion concentrations (of the order of 16 mol/l) is not attractive.

In a process according to the present invention fluoride salts are formed indicating that the BF₄— ion is at least partially destroyed in solution and is most likely to result from the hydrolysis of HBF₄ to yield HF. This has been confirmed by NMR. It is thought that the HF may be at least partially responsible for the zircaloy dissolution.

HBF₄ hydrolysis increases with temperature and increasing HBF₄ concentration and the hydrolysis leads to precipitation from the solution. Very high levels of precipitate can lead to the inhibition of the dissolution process if the precipitate adheres to the surface of the zircaloy cladding. The precipitate of ZrF₄.3H₂O absorbs the acid liquor and reduces its availability for reaction.

A mixture of 4M HBF₄/0.1M HNO₃ exhibits the fastest zircaloy dissolution rate at room temperature. Having regard to the requirements for dissolution of UO₂ fuel, the best acid mixture overall comprises 6M HBF₃/0.5M HBF₄. This represents a compromise between the achievement of a low precipitate level and a reduced dissolution rate.

Based on a test carried out at 6/8 M HNO₃/0.5/1M HBF₄:

A lowering of the [HBF₄] leads to less ZrF₄.3H₂O precipitate forming, but a lower UO₂ and zircaloy dissolution rate and reduced ZrO₂ solubility.

A lowering of the [HNO₃] appears to lead to less ZrF₄.3H₂O precipitate forming, a lower UO₂ and zircaloy dissolution rate, but a higher ZrO₂ solubility.

A two step dissolution process is a viable option if the presence of HBF₄ and Zr present a problem with solvent extraction in subsequent processing steps. Dissolution of zircaloy to 84 g/l can be achieved using refluxing 6M HNO₃/0.5M HBF₄ with the formation of negligible levels of precipitate.

### EXAMPLES

### UO₂ Dissolution Studies

Dissolution of UO₂ pellets to a concentration of 300 g/l were performed in the presence and absence of HBF₄. The results, shown in Table 1, indicate that addition of small amounts of HBF₄ (0.5M) retards the dissolution of UO₂ but further addition of larger amounts of HBF₄ results in faster dissolution rates than in HNO₃ alone.

TABLE 1

| | | Dissolu- | | | |
|---|---|---|---|---|---|
| [HBF]/ | [HNO₃]/ | tion | [U] | Initial | Final |
| M | M | Time/hrs | g/l | [H⁺]/M | [H⁺]/M |
| 0 | 6 | 12.167 | 311 ± 2 | 5.87 ± 0.10 | 3.52 ± 0.04 |
| 0.5 | 6 | 17.25 | 347 ± 2 | 6.36 ± 0.07 | 4.67 ± 0.06 |
| 1 | 6 | 10.5 | 321 ± 2 | 7.54 ± 0.08 | 5.23 ± 0.08 |
| 0 | 8 | 5.75 | 303 ± 2 | 7.91 ± 0.08 | 4.95 ± 0.07 |
| 0.5 | 8 | 8.75 | 234 ± 1 | 8.44 ± 0.08 | 5.74 ± 0.07 |
| 1 | 8 | 6.167 | 274 ± 1 | 9.50 ± 0.12 | 7.04 ± 0.07 |

### Combined UO₂ Fuel and Simulate Post Irradiated Zircaloy Cladding Dissolution Studies

Samples made up of UO₂ pellets in oxidised zircaloy cladding with PTFE end caps were dissolved under the conditions shown in Table 2.

TABLE 2

| | [HBF₄]/ | [HNO₃]/ | Wt | [U] | [Zr] | Initial | [H⁺]/M | Dissolution |
|---|---|---|---|---|---|---|---|---|
| Sample | M | M | UO₂/g | g/l | mg/ml | [H⁺]/M | at Time t | Time (hrs) |
| UZr 1.1 | 1 | 8 | 18.740 | 58.4 ± 0.5 | 20.9 ± 0.5 | 9.07 ± 0.10 | 5.61 ± 0.09 | 3.92 |
| UZr 1.2 | 1 | 8 | 18.740 | 170.8 ± 0.8 | 28.8 ± 0.5 | 9.07 ± 0.10 | 8.25 ± 0.09 | 6 |
| UZr 2.1 | 0.5 | 8 | 18.764 | 130.5 ± 0.8 | 76.4 ± 0.5 | NA | 4.91 ± 0.07 | 5.92 |
| UZr 2.2 | 0.5 | 8 | 18.764 | 227 ± 1 | 68.2 ± 0.5 | NA | 5.69 ± 0.07 | 12.25 |
| UZr 3.1 | 0.5 | 8 | 18.752 | 66.8 ± 0.5 | 24.5 ± 0.5 | 8.34 ± 0.08 | 5.76 ± 0.07 | 6.1 |
| UZr 3.2 | 0.5 | 8 | 18.752 | 164.1 ± 0.8 | 34.5 ± 0.5 | 8.34 ± 0.08 | 5.69 ± 0.07 | 13.5 |
| UZr 4.1 | 0.5 | 6 | 18.694 | 46.2 ± 0.4 | 77.0 ± 10 | 6.43 ± 0.07 | 2.85 ± 0.03 | 6 |
| UZr 4.2 | 0.5 | 6 | 18.694 | 331 ± 2 | 216 ± 7 | 6.43 ± 0.07 | 1.85 ± 0.05 | 30.17 |

### Test UZr1—Attempted Dissolution in 8M HNO₃/1M HBF₄ to 300 g/l U

First observations of cladding dissolution were a change in colour of the oxidised zircaloy cladding from dark brown to pale grey in colour. These were followed at approximately 50 minutes into the experiment by observation of a small amount of Nox building up in solution perhaps indicating the first breach of cladding thus allowing reaction between UO₂ and HNO₃. After 70 minutes a crack in the cladding was visible and soon afterwards the solution became progressively more yellow/green in colour as the UO₂ dissolved.

After 105 minutes the solution began to become cloudy indicating the onset of precipitation. By this time a ragged hole had formed in the cladding and this continued to grow as small pieces of the cladding broke away. This hole was approximately 0.5 cm in diameter after 130 minutes. Some of the precipitate was seen to adhere to the cladding surface and also to the UO₂ pellets giving them a silver-grey appearance.

After 200 minutes about half the cladding had dissolved but the UO₂ pellets appeared little changed although the solution colour indicated that dissolution was occurring. Analysis of the solution after 235 minutes showed a uranium concentration of 58.4 g/l equivalent to 17.7% dissolution. After 360 minutes the solution was sampled again and the experiment terminated. Analysis of the final solution indicated that 51.8% of the uranium had dissolved.

### Test UZr2—Attempted Dissolution in 8M HNO₃/0.5M HBF₄ to 300 g/l U

Initial cladding dissolution was slower than in the preceding example with the initial coloration change of the cladding being observed after 89 minutes cf. 46 minutes in the previous test.

A few small pin holds indicating breakthrough of the cladding was observed after 102 minutes cf. 50 minutes in test Uzr1. After 113 minutes these holes had joined up and a hole ca. 1 cm diameter was formed in the cladding. After 124 minutes the solution had become yellow in colour indicating that UO₂ dissolution was underway. After 129 minutes the hole in the cladding was estimated to be 1.5 cm diameter. The solution began to become murky after about 145 minutes indicating the onset of precipitation.

After 179 minutes almost one half of the cladding had dissolved and the UO₂ pellets fell free. After 380 minutes the solution was sampled, analysis of this indicated a lower uranium concentration than for the previous test after a similar period of time most probably due to the longer time required to breach the zircaloy cladding in the second test. The test was continued until a total elapsed time of 735 minutes. Analysis of the final solution showed a uranium concentration of 227 g/l.

### Attempted Dissolution in 8M HNO₃/0.5M HBF₄ to 150 g/l U

Experiment Uzr2 was repeated using a larger volume of solution. After 37 minutes the dark grey/brown colour of the zircaloy was noticeably faded with lighter areas clearly visible and the colour continued to lighten for the next 15 minutes or so. After 118 minutes breakthrough of the cladding was observed as evidenced by evolution of Nox from small pin holes in the cladding.

After 150 minutes the cladding was split wide open and the UO₂ pellets had fallen out, approximately two-thirds of the cladding had dissolved or fragmented. After 193 minutes the solution appeared to be slightly cloudy, perhaps indicating some precipitation.

After 387 minutes a sample of liquor was taken, analysis of this showed a uranium concentration of 66.8 g/l cf. 130.5 g/l for experiment Uzr2. Taking into account the dilution factor of 2 due to the larger liquor volume used in experiment Uzr3, the extent of uranium dissolution at this time is very similar for experiments Uzr2 and Uzr3. Refluxing continued for a further 414 minutes at which point visual indications indicated that all the uranium had dissolved and the experiment was terminated. Analysis of the final liquor showed a uranium concentration of 164.1 g/l.

### Test UZr4—Attempted Dissolution in 6M HNO₃/0.5M HBF₄ to 300 g/1 U

After approximately 87 minutes duration, the cladding surface began to show a light grey coloration and breakthrough occurred after approximately 95 minutes. The solution took on a cloudy appearance after about 145 minutes indicating the onset of precipitation. After 180 minutes, two large holes were observed in the cladding and after a further 30 minutes the cladding split apart.

Analysis of the solution after 360 minutes showed a uranium concentration of 46.2 g/l U. Dissolution was continued for a total of 1810 minutes, analysis of the final solution showed a uranium concentration of 331 g/l.

### CONCLUSION

The above described example demonstrates:

1. The successful dissolution of simulate fuel assembly.

2. The dissolution of both cladding and fuel.

3. Formation of ZrF₄.3H₂O precipitate (arising from zircaloy dissolution) inhibits dissolution by absorbing the acid liquor and so reducing its availability for reaction. The problem can be reduced by working to lower final uranium concentrations and lower nitric and fluoroboric acid concentrations.

4. Dissolution to 300 g/l uranium in 6M HNO₃ and 0.5M HBF₄ is a compromise achieving a low precipitant level but at a reduced dissolution rate.

5. A volatile silicon based precipitate is formed during the dissolution of oxidised zircaloy.

6. The levels of both the ZrF₄.3H₂O and the volatile silicon based precipitate can be reduced by lowering the concentrations of fluoroboric acid and nitric acid.

Accordingly the following conclusions have been drawn:

1. The formation and level of ZrF₄.3H₂O precipitate is governed by the relative concentrations of fluoroboric and nitric acids run by the temperature.

2. The formation of fluoride salts indicates that the BF₄— ion is (partially) destroyed in solution and is most likely to result from the hydrolysis of HBF₄ to yield HF. This has been confirmed by NMR. HF may be responsible for the zircaloy dissolution.

3. HBF₄ hydrolysis increases with temperature and increasing HBF₄ concentration and is consistent with the increased rate and levels of precipitate observed during the dissolution tests. However, very high levels of precipitate can lead to the inhibition of the dissolution process if the precipitate adheres to the surface of the zircaloy cladding.

4. 4M HBF₄/0.1M HN0₃ shows the fastest zircaloy dissolution rate at room temperature.

5. 6M HNO₃/0.5M HBF₄ was found to be the most suitable solution of those tested combined (single stage) dissolution of UO₂ fuel and simulate post-irradiated (oxidised) zircaloy cladding.

6. A two step dissolution process is a viable option if the presence of HBF₄ and Zr present a problem in the subsequent purification procedures. Dissolution of the zircaloy to 84 g/l can be achieved using refluxing 6M HN0₃/0.5M HBF₄ with the formation of negligible levels of precipitate.

7. The colouration of solutions during dissolution is due to the presence of NOx in solution. NO₂ is yellow, N₂O₃ is blue/green and HNO₂ and HNO₃ are clear.

8. A volatile silicon/boron oxide is produced during the dissolution of zirconium oxide or oxidised zircaloy in refluxing HBF₄/HNO₃ and precipitates onto the walls of the condenser. It is relatively easily removed when dry and could have originated from the glass of the reaction flask or form the fluorocilicic acid (H₂SiF₆) impurity in the HBF₄. Its formation is to be reduced by lowering the concentration of HBF₄.

9. Based on tests carried out at 6-8M HNO₃ and 0.5-1M HBF₄, a lowering of HBF₄ concentration leads to less ZrF₄.3H₂O precipitate forming, at a lower UO₂ and zircaloy dissolution rate and reduced Zr0₂ solubility. A lowering of the HNO₃ concentration leads to less ZRF₄.3H₂O precipitate forming, a lower UO₂ and zircaloy dissolution rate, but a higher ZrO₂ solubility.

1. A method for the dissolution of spent nuclear fuel pins or contaminated cladding, the method comprising contacting together the pins and both nitric and fluoroboric acids.

2. A method according to claim 1 wherein the nitric and fluoroboric acids are present in admixture.

3. A method according to claim 1 or claim 2 wherein the concentration of nitric acid is higher than that of fluoroboric acid.

4. A method according to any of the preceding claims wherein the concentration of HNO₃ is within the range of 4 to 8 mol/l.

5. A method according to claim 6 wherein the concentration of HNO₃ is about 6 mol/l.

6. A method according to any of the preceding claims wherein the concentration of HBF₄ is within the range of 0.1 to 2 mol/l.

7. A method according to claim 5 wherein the concentration of HBF₄ is about 0.5 mol/l.

8. A method according to any of the preceding claims where in the pins are cut into small pieces prior to contacting them with the acids.

9. A process for the reprocessing of spent nuclear fuel in which a method of any of the preceding claims forms a part.

10. Use of nitric and fluoroboric acids in the dissolution of spent nuclear fuel pins or contaminated cladding.
